(19) United States
(12) Patent Application Publication
(10) Pub. No.: US 2024/0120675 A1
(43) Pub. Date: Apr. 11, 2024

(54) Injection-molded component for integrally constructing an insulator element and a plug-type connector housing for a plug-type connector

(71) Applicant: ROSENBERGER HOCHFREQUENZTECHNIK GMBH & CO. KG, Fridolfing (DE)

(72) Inventors: Martin Steinbach, Waging A. See (DE); Michael Endlmaier, Kastl (DE); Florian Schnitzenbaumer, Tuntenhausen-Schoenau (DE)

(21) Appl. No.: 18/376,949

(22) Filed: Oct. 5, 2023

(30) Foreign Application Priority Data
Oct. 6, 2022 (EP) 22200136.4

(51) Int. Cl. H01R 13/405; H01R 24/50

(52) U.S. Cl. CPC H01R 13/405; H01R 24/50; H01R 12/707

(57) ABSTRACT

An injection-molded component for integrally constructing an insulator element and a plug-type connector housing for a plug-type connector has a first region which forms the insulator element, a second region which forms the plug-type connector housing and at least one connection region which connects the first region and the second region to each other. The first region and the second region are arranged relative to each other via the at least one connection region in such a manner that the insulator element is arranged in a leadthrough (opening) of the plug-type connector housing. The at least one connection region is in the form of a film hinge.

### FIELD OF THE INVENTION

The present invention relates to an injection-molded component for integrally constructing an insulator element and a plug-type connector housing for a plug-type connector.

The present invention further relates to a plug-type connector.

The present invention further relates to a printed-circuit board plug-type connector arrangement.

The present invention further relates to a method for producing a printed-circuit board plug-type connector arrangement.

### TECHNICAL BACKGROUND

In order to reduce the costs of producing plug-type connectors, it is advantageous to produce a plurality of plastics injection-molded components within a plug-type connector as a common plastics injection-molded component, as far as possible.

In a coaxial plug-type connector, the two dielectric components, that is to say, the insulator element and the plug-type connector housing, can be produced as a common injection-molded component in that the insulator element and the plug-type connector housing are connected to each other in one piece via at least one connection web.

U.S. Pat. No. 8,298,005 B2 discloses a common plastics injection-molded component for a printed-circuit board plug-type connector, wherein an insulator element and a part-region of a plug-type connector housing, that is to say, the engaging projections which are integrated in a plug-type connector housing for engaging the plug-type connector with a plug-type counter-connector at the end of the printed-circuit board plug-type connector on the printed-circuit board, are integrally connected to each other via a connection web.

If, in a plug-type connecter which is in the form of a printed-circuit board plug-type connector, the at least one connection web is arranged at the end of the printed-circuit board plug-type connector on the printed-circuit board, an interruption of the external conductor contact element and therefore an interruption of the shielding of the internal conductor contact element is limited by the at least one connection web only at the end of the printed-circuit board plug-type connector on the printed-circuit board.

In order also to shield the transition between the printed-circuit board plug-type connector and the printed-circuit board as effectively as possible, usually the external conductor contact element is extended over the end of the printed-circuit board plug-type connector on the printed-circuit board as far as the printed-circuit board. As a result of the connection webs which are still present, the external conductor contact element is exposed in the region of the axial extension of the at least one connection web. The shielding is consequently also not carried out in an optimum manner in the transition between the printed-circuit board plug-type connector and the printed-circuit board.

This is a state which it is advantageous to improve.

### SUMMARY OF THE INVENTION

Against this background, an object of the present invention is to provide the best possible shielding for a plug-type connector, in particular for a printed-circuit board plug-type connector.

According to the invention this object is achieved by an injection-molded component having the features disclosed herein and by a plug-type connector having the features disclosed herein.

Accordingly, there are provided:
an injection-molded component for integrally constructing an insulator element and a plug-type connector housing for a plug-type connector having
   a first region which forms the insulator element,
   a second region which forms the plug-type connector housing and
   at least one connection region which connects the first region and the second region to each other,
   wherein the first region and the second region are arranged relative to each other via the at least one connection region in such a manner that the insulator element is arranged in a leadthrough (opening) of the plug-type connector housing,
   wherein the at least one connection region is in the form of a film hinge.

A plug-type connector having
an internal conductor contact element,
an insulator element which surrounds the internal conductor contact element and which is produced by separating the first region of the injection-molded component,
an external conductor contact element which surrounds the insulator element and
a plug-type connector housing which surrounds the external conductor contact element and which is produced by separating the second region of the injection-molded component,
wherein the external conductor contact element is in the form of a sleeve and
is formed at least at a front axial end in a joining direction of the external conductor contact element in a circumferential direction at least in a substantially closed manner (in particular if this is possible in construction terms or as a result of production).

The recognition/notion which forms the basis of the present invention involves replacing in the injection-molded component the usually rigid connection webs or connection regions between the dielectric insulator element and the dielectric plug-type connector housing with a film hinge. Such film hinges can be separated usually without great expenditure of force by means of a separation member, in this case by the external conductor contact element, which is inserted into the plug-type connector between the plug-type connector housing and the insulator element during the assembly operation, of the plug-type connector. It is consequently possible to separate the insulator element and the plug-type connector housing in the assembly operation.

In order to carry out safe separation of the individual connection regions which are in the form of film hinges, the sleeve-like external conductor contact element is intended to be constructed at least in a substantially closed manner at least at a front axial end in a joining direction of the external conductor contact element in a circumferential direction.

A construction of the external conductor contact element, wherein the external conductor contact element is closed in a circumferential direction at a front axial end in a joining direction of the external conductor contact element does not exclude a slight recess or a gap which is caused by a production inaccuracy and by a production technology at least at the front axial end of the external conductor contact element, for example, a slight longitudinal slot which is unavoidable in an external conductor contact element which is produced by stamping/bending technology.

Preferably, the wording “substantially closed” may be understood so that the external conductor contact element is closed at the front axial end thereof (annularly) at least in such a manner that the electromagnetic shielding at the front axial end of the external conductor contact element is also not impaired in the case of potentially present, relatively small recesses (for example, production-related slots), in practice, in particular with respect to the electrical signals which are intended to be transmitted as a result of the application.

In this manner, the best possible shielding of the internal conductor contact element can be brought about by the external conductor contact element over the entire high-frequency signal path, that is to say, inside the plug-type connector and in a plug-type connector which is in the form of a printed-circuit board plug-type connector also in the transition region between the printed-circuit board plug-type connector and the printed-circuit board.

At least one connection region is intended to be formed in the injection-molded component. In the case of a single connection region, the single connection region preferably extends over the entire circumference, that is to say, over the entire angular range of 3600 relative to the longitudinal axis of the injection-molded component, in an intermediate region between the first region and the second region of the injection-molded component. In order to produce a better orientation of the first region relative to the second region, preferably two, three or four connection regions may be formed. However, it is also conceivable to have a greater number of connection regions than four connection regions, particularly if the connection regions are each formed in a narrow manner.

Preferably, the first region can be formed in a cylindrical manner and the second region can be formed in a hollow-cylindrical manner, and can consequently bring about the basic formation of an insulator element and a plug-type connector housing. Furthermore, the at least one connection region between the first region which forms the insulator element and the second region which forms the plug-type connector housing can be constructed at an axial end of the first region and second region. The at least one connection region may preferably be formed at a front axial end, in a joining direction of the external conductor contact element, of the first region or the second region. Consequently, the at least one connection element can be formed at the axial end of the first and second region at which the external conductor contact element which is inserted in the injection-molded component is discharged from the injection-molded component in the joining process.

A connection region which is formed on the injection-molded component in this manner allows a correct axial guiding of the external conductor contact element in the injection-molded component and consequently a separation, which is orthogonal to the longitudinal extent of the connection regions, of the connection regions by the correctly axially guided external conductor contact element. Such separation of the at least one connection region allows the smallest possible residues on the individual separated connection region both on the insulator element and on the plug-type connector housing. Alternatively, the at least one connection region can be formed in a central region of the first region and second region of the injection-molded component.

A construction of the at least one connection region in a plurality of axial positions of the injection-molded component is also conceivable. In this case, the connection regions, which are formed at different axial positions of the injection-molded component, are separated chronologically one after the other in the joining process of the external conductor contact element.

Finally, the connection region which is in the form of a film hinge can preferably be arranged in equidistant angular segments relative to each other. Consequently, the best possible orientation of the first region, which forms an insulator element, relative to the second region, which forms a plug-type connector housing, is brought about within the injection-molded component. However, a non-equidistant arrangement of the individual connection region is also conceivable.

In this instance, an injection-molded component is a plastics component which is produced by means of injection-molding—an initial molding method—in an injection-molding machine. In the injection-molding machine, the initial material of the injection-molded component, preferably a thermoplastic plastics material, is fluidized as a granulate (plasticized) and injected under pressure into a mold, the injection-molding tool. The fluidized granulate changes in the injection-molding tool into the solid state as a result of cooling and produces an injection-molded component which is molded in the mold of the injection-molding tool and which can be removed after the injection-molding tool is opened. According to modern injection-molding technology, plastics components can also be produced with a complicated shape and with wall thicknesses of different sizes. In particular, plastics components or regions of plastics materials can be produced with very thin wall thickness as regions, which are in the form of film hinges, of a plastics component. Consequently, an injection-molded component, which comprises a plurality of individual functional components which are integrally connected to each other via connection regions which are in the form of film hinges, can be produced in a single injection-molding operation in an injection-molding machine. By separating the functional components after the injection-molding, consequently, a plurality of simpler injection-molded components can be produced from a complex injection-molded component at the same time and therefore very efficiently. The functional components which are formed in an injection-molded component may be identical or different functional components. Consequently, it is also possible to produce the dielectric insulator element and the dielectric plug-type connector housing of a shielded plug-type connector integrally by means of a common injection-molded component. A plastics material which combines as well as possible high-frequency losses which are low for the insulator element and at the same time a high mechanical stability for the plug-type connector housing with low material costs can be selected as the material for the injection-molded component. To this end, preferably LCP (Liquid Crystal Polymer) is suitable as the plastics material. However, PA (polyamide) or PP (poly-propylene) are also conceivable. In order to allow a reliable connection between the insulator element and the plug-type connector housing during transport from the injection-molding process to the assembly process of the plug-type connector and at the same time reliable separation of the connection regions which are in the form of film hinges in the assembly step of the plug-type connector, the wall thickness of the individual film hinges has to be configured accordingly.

So that the insulator element and the plug-type connector housing are free from residues of the film hinges to the greatest possible extent after the separation process, the length of the individual film hinges is preferably intended to be formed to be as short as possible and/or an external conductor contact element is intended to be formed with sharp edges at the end on the printed-circuit board, that is to say, at the axial edge relative to the side of the insulator element and at the axial edge relative to the side of the plug-type connector housing.

The injection-molded component preferably contains the insulator element and the plug-type connector housing of a single plug-type connector. It is also conceivable for the insulator element and the plug-type connector housing of a plurality of preferably identical plug-type connectors to be contained in the injection-molded component. The pairs which belong to the individual plug-type connectors and which comprise an insulator element and a plug-type connector housing are arranged beside each other in the injection-molded component and also connected via connection regions which are in the form of film hinges. The separation of the pairs which comprise an insulator element and a plug-type connector housing is carried out before the assembly of the individual plug-type connectors by a suitable separation tool or a suitable separation machine or an automated separation apparatus.

In the injection-molded component, preferably a plurality of connection regions are formed according to the invention as a film hinge between the first region, which forms the insulator element of the plug-type connector, and the second region, which forms the plug-type connector housing. The term “film hinge” or “living hinge” or “integrated hinge” is intended to be understood in this instance and below to be a thin, flexible hinge which is formed from the same material as the two rigid regions—the first region and the second region of the injection-molded component—which connects it. In comparison with the first region and second region, the individual film hinge has a thinner wall thickness so that the rigid first region and the rigid second region can be bent relative to each other about a bending axis which is orientated transversely relative to the longitudinal axis of the film hinge. This ability to bend of the individual film hinges advantageously allows an exact orientation of the first region which forms an insulator element relative to the second region, which forms a plug-type connector housing, in the assembly process. During the assembly of the shielded plug-type connector, consequently, the longitudinal axis of the insulator element can be orientated coaxially relative to the longitudinal axis of the plug-type connector housing as an important prerequisite for correctly centering the components internal conductor contact element, insulator element, external conductor contact element and plug-type connector housing. This may be advantageous because the centering which can be brought about in the injection-molded component between the first region, which forms an insulator element, and the second region, which forms a plug-type connector housing, cannot typically comply with the quality of centering as required with a shielded plug-type connector. In addition to the ease of bending of the individual film hinges, particularly the ease of separation of the film hinges should be emphasized with respect to separating the insulator element and the plug-type connector housing.

The shielded plug-type connector may preferably be a coaxial plug-type connector, in which in particular the longitudinal axis of the single internal conductor contact element is orientated coaxially relative to the longitudinal axis of the external conductor contact element. However, the invention also covers other shielded plug-type connectors, such as differential shielded plug-type connectors or shielded plug-type connectors with a plurality of pairs of internal conductor contact elements. In all such shielded plug-type connectors, the longitudinal axis is orientated through the common center of all the internal conductor contact elements coaxially relative to the longitudinal axis of the external conductor contact element.

So that, as a result of the separation of the injection-molded component in the assembly process, an insulator element and a plug-type connector housing for a plug-type connector are produced in a correct position relative to each other, the first region of the injection-molded component can be arranged in a leadthrough (opening) of the second region via the individual connection regions.

With regard to correct orientation of the insulator element relative to the plug-type connector housing inside the plug-type connector, the insertion-side end of the first region can be arranged inside the injection-molded component beside the insertion-side end of the second region. In an equivalent manner, the wire-side end of the first region can be arranged beside the wire-side end of the second region or the end of the first region on the printed-circuit board can be arranged beside the end of the second region on the printed-circuit board inside the injection-molded component.

Advantageous embodiments and further developments will result from the description with reference to the Figures of the drawings.

It may be understood that the features which are mentioned above and the features which will be explained below can be used not only in the combination set out, but also in other combinations or alone without departing from the scope of the present invention.

In a preferred embodiment of the injection-molded component, a plurality of rib-like projections are formed at an external covering face of the first region which forms the insulator element and/or at an internal covering face of the second region which forms the plug-type connector housing. The rib-like projections each extend in a longitudinal axis of the first region and the second region, that is to say, in a longitudinal axis direction of the plug-type connector. They serve to guide the external conductor contact element of the plug-type connector in the assembly process. In addition, they can also serve to fix the external conductor contact element between the insulator element and the plug-type connector housing in the assembled state of the plug-type connector. The fixing by means of the rib-like projections is preferably carried out in a non-positive-locking manner (so-called “compression ribs”).

The plurality of rib-like projections are preferably formed in equidistant angular segments relative to each other at the external covering face of the first region and at the internal covering face of the second region in order to obtain the most central guiding possible of the external conductor contact element.

In another preferred embodiment of the rib-like projections, each individual rib-like projection in the first region may preferably be formed in an offset manner by an offset angle relative to the longitudinal axis of the injection-molded component with respect to the next-nearest rib-like projection in the second region. Alternatively, each individual rib-like projection can be positioned in the first region radially opposite a rib-like projection in the second region.

In addition to the already-described non-positive-locking fixing of the external conductor contact element via the rib-like projections which are formed on the internal wall covering face of the plug-type connector housing and the rib-like projections which are formed on the external covering face of the insulator element (so-called compression ribs), there can preferably also be formed on the external conductor contact element a plurality of fixing means with which a fixing of the external conductor contact element to the insulator element or to the plug-type connector housing can be carried out. In this instance, the fixing is preferably carried out in a positive-locking manner with fixing claws which are produced with a stamping/bending technique and which engage in a positive-locking manner in the dielectric material of the insulator element or the plug-type connector housing. An alternative positive-locking fixing is also possible via engaging projections or engaging protrusions which are formed on the external conductor contact element and which can be engaged in associated engaging recesses in the insulator element or in the plug-type connector housing.

In an additional preferable embodiment of the invention, a stop functionality is formed in the plug-type connector in order to axially fix the external conductor contact element in the plug-type connector. To this end, there is preferably formed in the external conductor contact element a diameter narrowing which corresponds to a diameter narrowing in the insulator element or in the plug-type connector housing. The diameter narrowing can preferably be constructed in a conical manner for both components (external conductor contact element and insulator element or plug-type connector housing). Alternatively, a curved diameter narrowing as a combination of a concave-curved and convex-curved diameter narrowing is also conceivable in the two components which are intended to be stopped. The diameter narrowing can advantageously additionally be used as a collection funnel functionality when the external conductor contact element is inserted into the intermediate space between the first region and the second region of the injection-molded component.

The plug-type connector is preferably in the form of a straight plug-type connector. Since, in a straight plug-type connector, all the components are arranged in a manner centered relative to each other and each have a linear longitudinal axis, simple insertion and introduction of the external conductor contact element through the injection-molded component can be carried out, that is to say, through the intermediate space between the insulator element and the plug-type connector housing. However, the production of a plug-type connector by means of the separation according to the invention of the film hinges of the injection-molded component can also be transferred to an angular plug-type connector.

The external conductor contact element which is and remains inserted between the first region and the second region of the injection-molded component, that is to say, between the insulator element and the plug type connector housing of the plug-type connector, is preferably integrally constructed. The one piece nature of the external conductor contact element allows higher mechanical stability of the external conductor contact element with respect to a multiple component nature, which higher mechanical stability promotes easier and reliable separation of all the film hinges of the injection-molded component. The one piece nature of the external conductor contact element further allows the production costs to be reduced.

The plug-type connector housing is preferably produced directly from the second region of the injection-molded component. Consequently, it is made from a purely dielectric material and is preferably formed in a non-coated manner. As a result of the shielding by the external conductor contact element, a metal coating of the plug-type connector housing is not necessary.

In a preferred embodiment of the invention, the plug-type connector is in the form of a printed-circuit board plug-type connector, in particular a shielded printed-circuit board plug-type connector. Consequently, the external conductor contact element projects at an end of the printed-circuit board plug-type connector on the printed-circuit board and each internal conductor contact element projects out of the plug-type connector housing in such a manner that the external conductor contact element can be electrically and mechanically connected to an external conductor contact region of a printed-circuit board and each internal conductor contact element can be electrically and mechanically connected to an associated internal conductor contact region of the printed-circuit board.

A soldered connection can be used as a preferred connection technology. However, a press connection by means of pressing pins which are formed at the axial end of the internal conductor contact element or the external conductor contact element and which can be pressed into associated metal-coated holes in the printed-circuit board is also conceivable. In this case, any technical embodiment of a printed-circuit board is covered as a printed-circuit board, for example, a conventional printed-circuit board made from glass-fiber-reinforced epoxy resin, a printed-circuit board which is enclosed in the housing of an integrated circuit or the substrate of an integrated circuit with associated contacting faces.

Since the connection regions, which are each in the form of a film hinge, of the injection-molded component are separated after the insertion of the external conductor contact element into the printed-circuit board plug-type connector, preferably a sleeve-like external conductor contact element with an axial portion which is constructed in a closed manner outside the plug-type connector housing in a circumferential direction can be used. With respect to the prior art, consequently, a complete shielding of each internal conductor contact element in the transition region between the printed-circuit board plug-type connector and the printed-circuit board which is intended to be contacted can advantageously be achieved. If the sleeve-like external conductor contact element is also closed completely in a circumferential direction over the entire longitudinal extent of the plug-type connector housing, a complete shielding is possible over the entire high-frequency signal path, that is to say, inside the printed-circuit board plug-type connector and in the transition region between the printed-circuit board plug-type connector and the printed-circuit board.

In order to optimize the electrical connection and in particular the mechanical connection between the printed-circuit board plug-type connector and the printed-circuit board, there are formed at the end of the preferably sleeve-like external conductor contact element on the printed-circuit board a plurality of pin-like extensions which can be inserted in associated, preferably metal-coated holes in the region of the external conductor contact region of the printed-circuit board. These pin-like extensions and the associated holes thereof are preferably arranged with spacing from each other with equidistant angular spacings.

The pin-like extensions are preferably electrically and mechanically connected via a soldered connection with respect to the metal-coated holes. Alternatively, the pin-like extensions can also be inserted via a pressing-in technique in a non-positive-locking manner in the associated metal-coated hole and an electrical and mechanical connection can be produced.

In another preferred embodiment of the invention, the end of the preferably sleeve-like external conductor contact element of the printed-circuit board plug-type connector on the printed-circuit board can have an end face which is orientated orthogonally to a longitudinal axis of the printed-circuit board plug-type connector. In a typically planar external conductor contact region on the printed-circuit board and a printed-circuit board plug-type connector which is correctly orientated relative to the printed-circuit board, consequently, it is ideally possible to bring about complete contacting or in the real environment virtually complete contacting of the external conductor contact element with the external conductor contact region of the printed-circuit board.

The invention also covers a printed-circuit board plug-type connector arrangement which has a printed-circuit board plug-type connector and a printed-circuit board. In the printed-circuit board plug-type connector arrangement, the external conductor contact element of the printed-circuit board plug-type connector is electrically and mechanically connected to an external conductor contact region of the printed-circuit board and each internal conductor contact element of the printed-circuit board plug-type connector is electrically and mechanically connected to an associated internal conductor contact region of the printed-circuit board. Consequently, both through hole technology (THT) and surface mounted device (SMD) technology are also covered by the invention in the electrical and mechanical contacting between the contact elements of the printed-circuit board plug-type connector and the contact regions of the printed-circuit board. The technical features which have been described previously and those described below for the injection-molded component according to the invention and the plug-type connector according to the invention also apply in an equivalent manner to the printed-circuit board plug-type connector arrangement according to the invention, and vice versa.

Finally, the invention also covers a method for producing a printed-circuit board plug-type connector arrangement. The method according to the invention has at least the following method steps:
providing the injection-molded component,
inserting an external conductor contact element between the first region and the second region,
separating the insulator element and the plug-type connector housing by means of severing the at least one connection region by the inserted external conductor contact element,
introducing the internal conductor contact through a leadthrough (opening) which is formed in the insulator element and
connecting the external conductor contact element to the external conductor contact region of the printed-circuit board and the internal conductor contact element to the internal conductor contact region of the printed-circuit board.

The explanations which have been described previously and which are described below for the injection-molded component according to the invention, the plug-type connector according to the invention and the printed-circuit board plug-type connector arrangement according to the invention also apply to the method according to the invention for producing a printed-circuit board plug-type connection arrangement in an equivalent manner, and vice versa.

The above embodiments and further developments can be freely combined with each other, if advantageous. Additional possible embodiments, further developments and implementations of the invention also include non-explicitly mentioned combinations of features, which have been described previously or features which are described below with reference to the exemplary embodiments, of the invention. In this case, the person skilled in the art will particularly also add individual aspects as improvements or additions to the respective basic form of the present invention.

### DESCRIPTION OF CONTENT OF DRAWINGS

The present invention is explained in greater detail below with reference to the exemplary embodiments which are set out in the schematic Figures of the drawings. In the drawings:

FIG. 1A shows a cross sectional illustration of a printed-circuit board plug-type connector arrangement according to the invention in a first intermediate assembly state,

FIG. 1B shows a cross sectional illustration of a printed-circuit board plug-type connector arrangement according to the invention in a second intermediate assembly state,

FIG. 1C shows a first cross sectional illustration of a printed-circuit board plug-type connector arrangement according to the invention in the completely assembled state,

FIG. 1D shows a second cross sectional illustration of a printed-circuit board plug-type connector arrangement according to the invention in the completely assembled state,

FIG. 1E shows a plan view at the printed-circuit board side of a printed-circuit board plug-type connector arrangement according to the invention,

FIG. 1F shows a plan view at the insertion side of a printed-circuit board plug-type connector arrangement according to the invention,

FIG. 2A shows an exploded view of a printed-circuit board plug-type connector arrangement according to the invention, and

FIG. 2B shows an isometric illustration of a printed-circuit board plug-type connector arrangement according to the invention.

The appended Figures of the drawings are intended to convey an additional understanding of the embodiments of the invention. They depict embodiments and are used in connection with the description to explain principles and concepts of the invention. Other embodiments and many of the advantages mentioned result with regard to the drawings. The elements of the drawings are not necessarily shown in a manner true to scale relative to each other.

In the Figures, identical, functionally identical and identically functioning elements, features and components—unless otherwise set out—are referred to using the same reference numerals.

The Figures are described below in a coherent and general manner.

### DESCRIPTION OF EMBODIMENTS

The injection-molded component according to the invention, the printed-circuit board plug-type connector according to the invention, the printed-circuit board plug-type connector arrangement according to the invention and the method according to the invention for producing the printed-circuit board plug-type connector arrangement are described below with reference to the Figures.

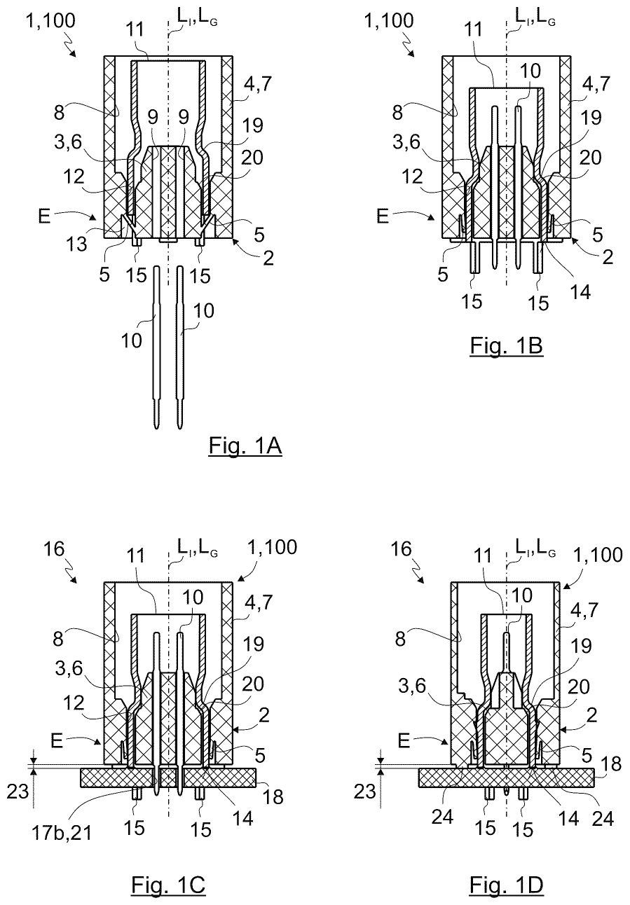

FIG. 1A shows a plug-type connector 100 which is in the form of a straight printed-circuit board plug-type connector 1 in an intermediate assembly step, in which the individual components have not yet been connected to each other in accordance with positions. It is possible to see the dielectric injection-molded component 2 with a first region 3, a second region 4 and a plurality of connection regions 5 which connect the first region 3 and the second region 4 to each other and which are each in the form of a film hinge. The first region 3 of the injection-molded component 2 forms the insulator element 6 of the printed-circuit board plug-type connector 1 and the second region 4 forms the plug-type connector housing 7 of the printed-circuit board plug-type connector 1.

The cylindrically formed first region 3 is connected via the connection region 5 to the hollow-cylindrically formed second region 4 in such a manner that the first region 3 is arranged in a leadthrough (opening) 8 of the second region 4. Furthermore, the first region 3 is connected via the connection regions 5 to the second region 4 in such a manner that a longitudinal axis L_{I} of the first region 3 and therefore of the insulator element 6 ideally comes to rest on a longitudinal axis LG of the second region 4 and therefore of the plug-type connector housing 7. Consequently, the first region 3 and therefore the insulator element 6 are arranged coaxially relative to the second region 4 and therefore to the plug-type connector housing 7.

The first region 3 and therefore the insulator element 6 has two leadthroughs (openings) 9 which extend in the longitudinal axis direction L_{I} and in which an internal conductor contact element 10 can be received. The printed-circuit board plug-type connector 1 is consequently in the form of a differential plug-type connector. However, this is not intended to be interpreted in a limiting manner because the printed-circuit board plug-type connector 1 may also contain only an internal conductor contact element 10 or a relatively large number of internal conductor contact elements, for example, three internal conductor contact elements, four internal conductor contact elements, five internal conductor contact elements, etc.

The connection regions 5 are each formed at an axial end E of the first region 3 and the second region 4 of the injection-molded component 2. The axial end E is the axial end, which is at the front in a joining direction of the external conductor contact element 11 of the plug-type connector 100, of the first region 3 and the second region 4 of the injection-molded component 2. This is the axial end of the printed-circuit board plug-type connector 1 on the printed-circuit board in a printed-circuit board plug-type connector 1. In a plug-type connector 100 which is in the form of a wire plug-type connector, a housing plug-type connector or a fitted plug-type connector, the axial end is located at the insertion side.

In the intermediate assembly step which is illustrated in FIG. 1A, the external conductor contact element 11 is introduced in an annular leadthrough (opening) 12 between the first region 3, that is to say, the insulator element 6, and the second region 4, that is to say, the plug-type connector housing 7, in such a manner that the external conductor contact element 11 is still located remote from the connection regions 5 which are in the form of film hinges and consequently the connection regions 5 are not yet separated from the external conductor contact element 11.

In a final assembly step of the printed-circuit board plug-type connector 1 which corresponds to an intermediate assembly step of the printed-circuit board plug-type connector arrangement 13 and which is illustrated in FIG. 1B, the external conductor contact element 11 is positioned in its definitive position inside the printed-circuit board plug-type connector 1. The connection regions 5 which are each in the form of film hinges are separated by the external conductor contact element 11. The separated connection regions 5 which are still connected in the embodiments of FIG. 1B, for example, to the second region 4 are urged by the external conductor contact element 11 out of the annular leadthrough (opening) 12 and are located in a recess 13, which radially adjoins the annular leadthrough (opening) 12, of the plug-type connector housing 7.

Pin-like extensions or contact pins 15 which are inserted into associated holes 17a of the printed-circuit board 18 for mechanically stabilizing the printed-circuit board plug-type connector arrangement 16, as can be seen in FIGS. 1C and 1D, are formed at the end 14 of the external conductor contact element 11 on the printed-circuit board.

An axial central portion of the external conductor contact element 11 has a conically formed diameter narrowing 19 which is supported on a similarly conically formed diameter narrowing 20 of the insulator element 6 in order to axially fix the external conductor contact element 11 in the printed-circuit board plug-type connector 1.

In the final assembly step of the printed-circuit board plug-type connector 1 according to FIG. 1B, the two internal conductor contact elements 10 are inserted in the associated leadthroughs (openings) 9 of the insulator element 6 in a positionally correct manner.

In the printed-circuit board plug-type connector arrangement 16 according to FIGS. 1C and 1D, the printed-circuit board plug-type connector 1 is electrically and mechanically connected to the printed-circuit board 18. The internal conductor contact elements 10 are inserted in associated holes 17b of the printed-circuit board 18. The internal conductor contact elements 10 can electrically contact the metal-coated internal wall of the associated hole 17b which constitutes the internal conductor contact region 21 of the printed-circuit board 18 either by means of a soldered connection or by means of a press-in connection.

The external conductor contact element 11 contacts an external conductor contact region 22, that is to say, a preferably annularly formed external conductor contact face, and is typically electrically and mechanically connected via a soldered connection to the external conductor contact region 22. In a transition region 23 between the printed-circuit board plug-type connector 1 and the printed-circuit board 18, the two internal conductor contact elements 10 are completely surrounded by the sleeve-like external conductor contact element 1 and consequently shielded.

There is formed at the end of the plug-type connector housing 7 of the printed-circuit board plug-type connector 1 on the printed-circuit board a support region 24 which is supported on the printed-circuit board 18 and which is used to mechanically stabilize the entire printed-circuit board plug-type connector arrangement 16 and to correctly orientate the printed-circuit board plug-type connector 1 with respect to the printed-circuit board 18.

In the plan view of the injection-molded component 2 of FIGS. 1E and 1F at the insertion side and the printed-circuit board side, there can be seen the rib-like projections 25 which are formed on an internal covering face 26 of the second region 4 and at an external covering face 27 of the first region 3. The rib-like projections 25 extend in a longitudinal axis direction of the first region 3 or the second region 4 and are arranged in an approximately uniformly distributed manner over the internal covering face 26 of the second region 4 and the external covering face 27 of the first region 3. They are used to guide the external conductor contact element 11 in the assembly process and to fix the external conductor contact element 11 between the insulator element 6 and the plug-type connector housing 7.

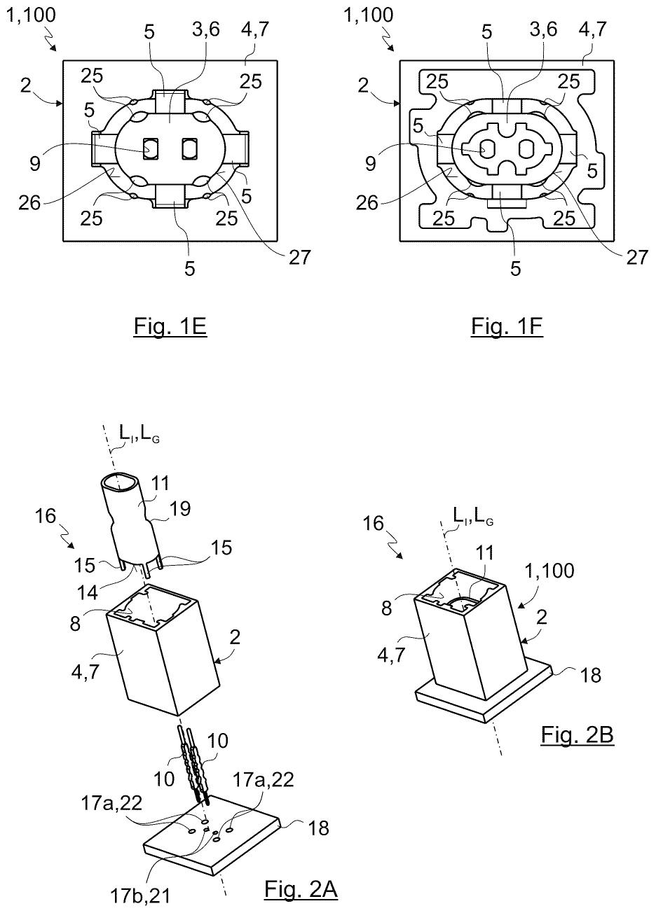

The exploded illustration of FIG. 2A depicts an arrangement of the individual components of the printed-circuit board plug-type connector arrangement 16 in the non-assembled state. The isometric illustration of FIG. 2B shows the printed-circuit board plug-type connector arrangement 16 in the assembled state.

Although the present invention has been completely described above with reference to preferred exemplary embodiments, it is not limited thereto but instead can be modified in many manners.

We claim:

1. An injection-molded component for integrally constructing an insulator element and a plug-type connector housing for a shielded plug-type connector, the injection-molded component comprising:
a first region which forms the insulator element,
a second region which forms the plug-type connector housing, and
an at least one connection region which connects the first region and the second region to each other,
wherein the first region and the second region are arranged relative to each other via the at least one connection region in such a manner that the insulator element is arranged in a leadthrough of the plug-type connector housing, and
wherein the at least one connection region is in the form of a film hinge.

2. The injection-molded component of claim 1, further comprising a plurality of rib-like projections which extend in a longitudinal axis direction of the first region and the second region,
wherein the plurality of rib-like projections is formed at an external covering face of the first region, at an internal covering face of the second region, or at both the internal and external covering faces in order to guide an external conductor contact element of the plug-type connector.

3. The injection-molded component of claim 2, wherein at least two rib-like projections of the plurality of rib-like projections are arranged in equidistant angular segments relative to each other.

4. The injection-molded component of claim 2,
wherein the plurality of rib-like projections comprises (i) a first plurality of rib-like projections which are formed on the external covering face of the first region, and (ii) a second plurality of rib-like projections which are formed on the internal covering face of the second region, and
wherein the first plurality of rib-like projections is formed in an offset manner by an offset angle relative to the second plurality of rib-like projections.

5. A shielded plug-type connector comprising:
an internal conductor contact element,
an insulator element which surrounds the internal conductor contact element,
an external conductor contact element which surrounds the insulator element, and
a plug-type connector housing which surrounds the external conductor contact element,
wherein the insulator element and the plug-type connector housing are produced by separating two regions of an injection-molded component,
wherein the external conductor contact element is in a shape of a sleeve having a front axial end (E), and
wherein, at least at the front axial end (E) in a joining direction, the external conductor contact element is formed in a closed manner in a circumferential direction.

6. The shielded plug-type connector of claim 5,
wherein at least one of (a) an internal wall of the external conductor contact element and (b) an external wall of the external conductor contact element, comprises at least one fixing means for fixing the external conductor contact element to at least one of the insulator element and the plug-type connector housing.

7. The shielded plug-type connector of claim 5,
wherein the external conductor contact element comprises a diameter narrowing, which corresponds to one of (a) a diameter narrowing in the insulator element or (b) a diameter narrowing in the plug-type connector housing, in order to axially fix the external conductor contact element in the shielded plug-type connector.

8. The shielded plug-type connector of claim 5,
wherein the shielded plug-type connector is a straight plug-type connector.

9. The shielded plug-type connector of claim 5,
wherein the external conductor contact element is integrally constructed.

10. The shielded plug-type connector of claim 5,
wherein the plug-type connector housing is constructed in a non-coated manner.

11. The shielded plug-type connector of claim 5,
wherein the shielded plug-type connector is a printed-circuit board plug-type connector, and
wherein the external conductor contact element and the internal conductor contact element project out of the plug-type connector housing in such a manner that the external conductor contact element can be electrically contacted with an external conductor contact region of a printed-circuit board and the internal conductor contact element can be electrically contacted with an internal conductor contact region of the printed-circuit board.

12. The shielded plug-type connector of claim 11,
wherein an axial portion of the external conductor contact element which is located outside the plug-type connector housing is constructed in a closed manner in a circumferential direction.

13. The shielded plug-type connector of claim 11,
wherein the external conductor contact element has a sleeve-like shape, a first end of which is configured for positioning on the printed circuit board, and
wherein an end face of the first end is orientated orthogonally to a longitudinal axis of the printed-circuit board plug-type connector.

14. The shielded plug-type connector of claim 11,
wherein the first end of the external conductor contact element is extended by a plurality of contact pins arranged in equidistant angular segments relative to each other.

15. A printed-circuit board plug-type connector arrangement comprising:
a shielded plug-type connector in a form of a printed-circuit board plug-type connector comprising:
i) an internal conductor contact element,
ii) an insulator element surrounding the internal conductor contact element,
iii) an external conductor contact element surrounding the insulator element, and
iv) a plug-type connector housing surrounding the external conductor contact element,
wherein the insulator element and the plug-type connector housing are produced by separating two regions of an injection-molded component,
wherein the external conductor contact element is in a shape of a sleeve having a front axial end (E), and
wherein, at least at the front axial end (E) in a joining direction, the external conductor contact element is formed in a closed manner in a circumferential direction;
and
a printed-circuit board comprising an external conductor contact region and an internal conductor contact region,
wherein the external conductor contact element is electrically and mechanically connected to the external conductor contact region of the printed-circuit board and the internal conductor contact element is electrically and mechanically connected to the internal conductor contact region of the printed-circuit board.

16. The printed-circuit board plug-type connector arrangement of claim 15, wherein (i) the external conductor contact element is electrically and mechanically connected to the external conductor contact region of the printed-circuit board by a soldered connection, (ii) the internal conductor contact element is electrically and mechanically connected to the internal conductor contact region of the printed-circuit board by a soldered connection, or (iii) the external conductor contact element is electrically and mechanically connected to the external conductor contact region of the printed-circuit board by a first soldered connection and the internal conductor contact element is electrically and mechanically connected to the internal conductor contact region of the printed-circuit board by a second soldered connection.

17. The printed-circuit board plug-type connector arrangement of claim 15, wherein at least one of (a) an internal wall of the external conductor contact element and (b) an external wall of the external conductor contact element, comprises at least one fixing means for fixing the external conductor contact element to at least one of (i) the insulator element and (ii) the plug-type connector housing.

18. The printed-circuit board plug-type connector arrangement of claim 15, wherein the external conductor contact element comprises a diameter narrowing which corresponds to one of (a) a diameter narrowing in the insulator element or (b) a diameter narrowing in the plug-type connector housing, in order to axially fix the external conductor contact element in the shielded plug-type connector.

19. The printed-circuit board plug-type connector arrangement of claim 15, wherein the shielded plug-type connector is a straight plug-type connector.

20. A method for producing a printed-circuit board plug-type connector arrangement, the method comprising the steps of:
providing an injection-molded component comprising a first region representing an insulator element, a second region representing a plug-type connector housing, and an at least one connection region connecting the first and second regions,
inserting an external conductor contact element between the first region and the second region,
separating the insulator element and the plug-type connector housing by means of separating the at least one connection region by the inserted external conductor contact element,
introducing the internal conductor contact through a leadthrough in the insulator element,
connecting the external conductor contact element to an external conductor contact region of a printed-circuit board, and
connecting the internal conductor contact element to an internal conductor contact region of the printed-circuit board.
